(19) United States
(12) Patent Application Publication
(10) Pub. No.: US 2014/0327421 A1
(43) Pub. Date: Nov. 6, 2014

(54) SWITCHING REGULATOR AND METHOD FOR CONTROLLING THE SWITCHING REGULATOR

(71) Applicant: Nobuharu Arao, Tokyo (JP)

(72) Inventor: Nobuharu Arao, Tokyo (JP)

(73) Assignee: RICOH COMPANY, LTD., Tokyo (JP)

(21) Appl. No.: 14/265,470

(22) Filed: Apr. 30, 2014

(30) Foreign Application Priority Data
May 1, 2013 (JP) 2013-069291

(51) Int. Cl. H02M 3/156

(52) U.S. Cl. CPC H02M 3/156
USPC 323/282

(57) ABSTRACT

By controlling the duty of a switching pulse signal and a switching frequency of the signal in response to changes in load current, the ripple of the output voltage can be reduced and switching losses can be reduced and thus a switching regulator that is efficient can be provided.

### BACKGROUND

1. Technical Field

The present invention relates to a switching regulator and method for controlling the switching regulator

2. Description of the Related Art

In recent years, mobile information terminals, such as smart phone, mobile phone, PDA (Personal Digital Assistant), etc., are typically configured to include a device that can generate a drive voltage higher than an output voltage of battery because such drive voltage is used to operate, for example, the LED backlight of the LCD monitor.

In portable information terminals, in which Li (Lithium) ion battery is widely used, an output voltage of the Li ion battery is typically about 3.5V, and is about 4.2V even when fully charged. As described above, since the LED backlight of the terminal typically requires a voltage higher than the output voltage of the battery as the driving voltage for the terminal, a DC-DC converter is used for LED. Further, the light quantity of the LED corresponds to the amount of current flow electrically supplied from the drive circuit, Such amount of current is typically controlled by a step-up (boost) switching regulator, such as a DC-DC converter.

It is possible with regard to the efficiency of the switching regulator system, to separate the switching losses of switching elements in a host device from the loss of remaining elements of the device. The switching losses of the device increase when the load includes one or more light generation elements. Switching loss refers to loss of voltage and/or current generated by transitions between turn-OFF and turn-ON, such as when the ON/OFF switching cycle is repeated at a certain cycle.

In such circumstances, it is possible to achieve higher efficiency through reduction of the switching losses of the device by decreasing the switching frequency. Further, as a method of controlling switching frequency when the loads include light generation elements, PWM (Pulse Frequency Modulation) control is known. However, in PFM control of switching, there is commonly an effect known as “ripple” in which the actual voltage exceeds the desired voltage by a ripple voltage. Such ripple voltage causes an extended ON period and consequently unnecessary power consumption and possibly unnecessary wear of the circuit and/or circuit elements, for example, in the load.

In Patent Document 1, together with the absence of the frequency of the drive signal of the switching element drops below the upper limit of the audible range, for the purpose of reducing the ripple of the output voltage, and applying the PFM control method described above, a dropout voltage LED driving power supply device that monitors and controls the switching frequency is proposed.

When using the method proposed in Patent Document 1 for controlling the switching frequency in PFM control, the pulse width of either on or off of the switching element is fixed. There is a problem in that the number of switching transitions in an interval cannot be properly controlled, and consequently ripple voltage is increased as a result.

### BRIEF SUMMARY

In an aspect of this disclosure, there is provided a switching regulator that is configured to improve efficiency when a load including light generation element(s) is connected thereto, while maintaining low ripple voltage.

In another aspect of this disclosure, a switching regulator includes a converter circuit for converting an input voltage into a predetermined constant voltage and outputting the predetermined constant voltage to a load, and a control circuit for controlling duty ratio of a switching signal used to control switching of the switching regulator and the frequency of the switching signal in accordance with the amount of load current.

When such aspects are employed, ripple voltage increase can be suppressed and efficiency can be improved for loads that include light generation elements.

Other aspects, features and advantages will become more apparent from the following detailed description when read in conjunction with the accompanying drawings.

### BRIEF DESCRIPTION OF THE DRAWINGS

FIG. 1 is a schematic diagram of a circuit configuration of a switching regulator in an embodiment of this disclosure.

FIG. 2 is an overview of a frequency control circuit that can be employed in a switching regulator, according to an embodiment of this disclosure

FIG. 3 is a timing chart showing operation of the frequency control circuit illustrated.

### DETAILED DESCRIPTION OF THE PREFERRED EMBODIMENTS

Hereinafter, embodiments are explained by referring to the accompanying drawings. In the drawings, the same reference symbol may be attached to the same portions of the embodiments, and thereby duplicated explanations may be omitted.

An embodiment of the switching regulator of this disclosure will be described below with reference to the drawings. The description and terminology used herein are not intended to limit this disclosure. In the drawings, the same numbers are attached to the same or corresponding parts and overlap of description is simplified or omitted as appropriate.

While controlling switching frequency according to load current, a switching regulator in an embodiment of this disclosure also controls the duty ratio of a switching pulse, to reduce the ripple of the output voltage while reducing the switching loss.

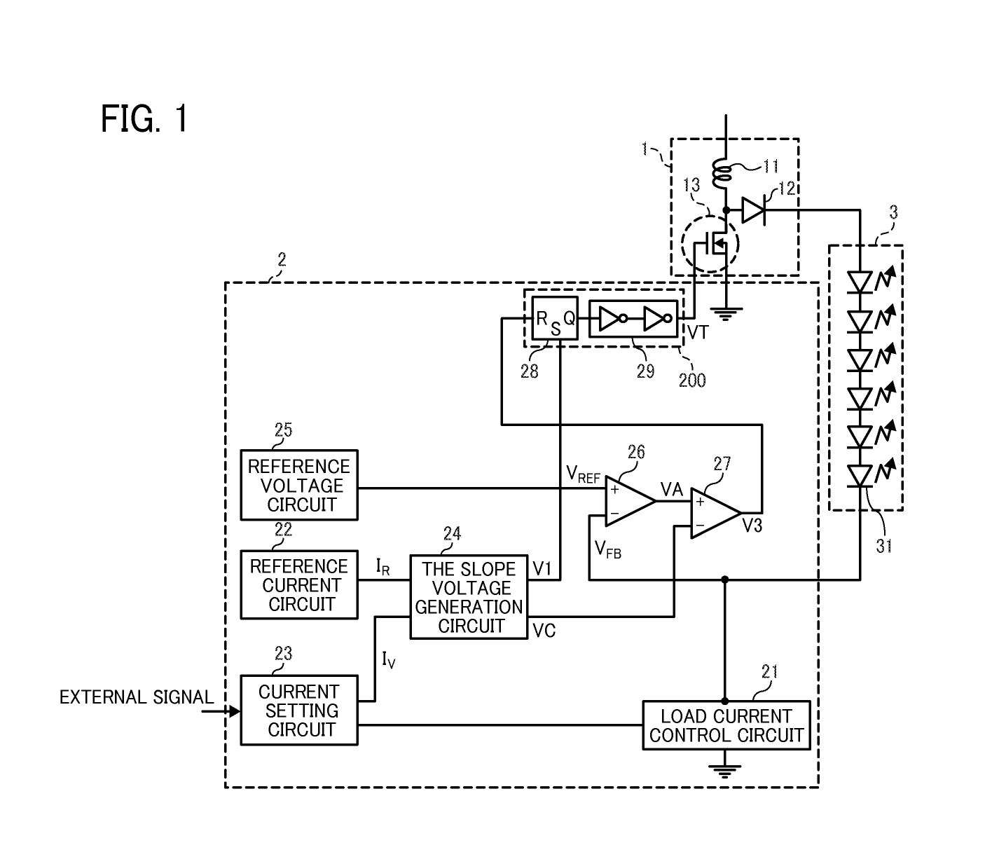

In the embodiment shown in FIG. 1, the switching regulator includes a converter circuit unit 1, a control circuit unit 2, and a load unit 3.

The load unit 3 is connected between the control circuit unit 2 and the converter circuit 1. In the description of the present exemplary embodiment, the load unit 3, such as a backlight unit of a portable information terminal, can be configured to include a plurality of LED elements 31, but is not limited thereto, and may be a micro hard disk drive (Micro HDD) , audio (such as an external audio component), an external component connected by, for example, a USB interface, etc.

The converter circuit unit 1 includes at least MOSFET 13, Schottky barrier diode 12 and inductor 11.

The MOSFET 13 can operate as a high-speed (e.g., 1.2 MHz) switching element in which ON/OFF is controlled based on a control signal outputted from the control circuit unit 2, and the MOSFET 13 boosts the input voltage VIN that is input through the inductor 11. In the converter circuit unit 1, the boosted voltage is rectified by the Schottky barrier diode 12, and is output to the anode of the load unit 3. The converter circuit 1 outputs to the load unit 3 output voltage VL of a predetermined level, such voltage having been converted from the input voltage VIN input from the outside.

The control circuit unit 2 includes a load current control circuit 21, a reference current circuit 22, a current setting circuit 23, a slope voltage generation circuit 24, a reference voltage circuit 25, an error amplifier circuit 26, a PWM comparator 27, and RS flip-flop 28, and a drive circuit 29. Further, the control circuit unit 2 may be configured as an IC (Integrated Circuit) having both the function of controlling the output current and the function of controlling switching frequency. The control circuit unit 2 controls the switching frequency according to the amount of the load current flowing through the load unit 3.

The reference current circuit 22 outputs to the slope voltage generating circuit 24 a reference current value VRC (corresponding to minimum operating current level of load, that is, when the current supplied by current source I1 is below the minimum operating current level, the signal output by the slope voltage generation circuit 24 would include no pulses) for determining the lowest frequency of the slope voltage.

The current setting circuit 23 (which may be a combination of one or more transistors and/or resistors) outputs a voltage VLC to set the load current value of the load unit 3 (that is, load current flowing through, and out of, the load and through the local current control circuit 21), and the current setting circuit 23 outputs the variable current value Iv to vary the inclination of the slope voltage based on an external signal (“EXTERNAL SIGNAL” in FIG. 1). The load current control circuit 21 controls the load current flowing through the load unit 3, in accordance with the current value set by the current setting circuit 23. For example, the load current control circuit 21 is composed of a MOS transistor. The voltage output from the current setting circuit 23 is applied to the gate of the MOS transistor.

The reference voltage circuit 25 outputs a predetermined reference voltage VREF to non-inverting (+) input terminal of the error amplifier 26. The error amplifier 26 outputs an error voltage signal VA obtained by amplifying the voltage difference between the reference voltage VREF and the feedback voltage VFB which is proportional to the voltage VL input to the load unit 3. The slope voltage generation circuit 24 generates a square wave signal V1, which corresponds to the predetermined level of the slope voltage VC, and the slope voltage VC having a slope that is varied in accordance with the amount of the output current IL controlled by the current control circuit 2.

Specifically, the voltage VFB of the cathode portion C of the bottom LED in the load unit 3 is input to the error amplifier 26. The error amplifier circuit 26 outputs to the PWM comparator 27 a voltage difference VA between the reference voltage VREF input to the non-inverting input terminal (+) and the voltage VB input to the inverting input terminal (−).

Further, the PWM comparator 27 generates a PWM control signal V3 on the basis of a comparison between the error voltage signal VA output from the error amplifier circuit 26, and the slope voltage signal VC output from the slope voltage generator circuit 24. The PWM control signal V3 is a square wave signal having some low signals and some high signals. The PWM comparator 27 outputs a high signal when the slope voltage signal VC from the slope of the voltage generation circuit 24 is higher than the error signal voltage VA of the error amplifier circuit 26. The PWM comparator 27 outputs a low signal when the slope voltage signal VC from the voltage generation circuit 24 is less than the error signal voltage VA of the error amplifier circuit 26.

The RS flip-flop 28 generates and outputs to the driving circuit 29 a signal for determining the OFF time or ON time of the switching operation in MOSFET 13 based on the square wave signal V1 output from the slope voltage generator circuit 24 and the PWM control signal V3 that is output from the PWM comparator 27.

The drive circuit 29 generates an ON or OFF signal VT based on the output signal from the RS flip-flop 28. The ON or OFF signal VT which is generated by the drive circuit 29 is output to the gate of MOSFET 13. The driving circuit 29 and the RS flip-flop 28 collectively constitute a switching drive voltage generating circuit 200 in the example shown in FIG. 1. The switching driving voltage generating circuit 200 is a circuit for generating a switching drive voltage of VT for switching operation to the converter circuit 1 on the basis of the PWM control signal V3 and the square wave signal V1.

In the negative feedback loop as described above, for example, the voltage VFB of the cathode portion C of the bottom LED of the load unit 3 is controlled to a constant voltage, corresponding to the control load current IL set by the load current control circuit 21. If the value of the constant voltage is too low, the current does not flow because it is below the operating point of the circuit. Further, if the constant voltage value is too large, an excessive current (that is, exceeding the operational characteristic specified by the specification for the load, and exceeding the set current), flows through the local unit 3. Therefore, it is necessary to control the voltage VFB within a predetermined range.

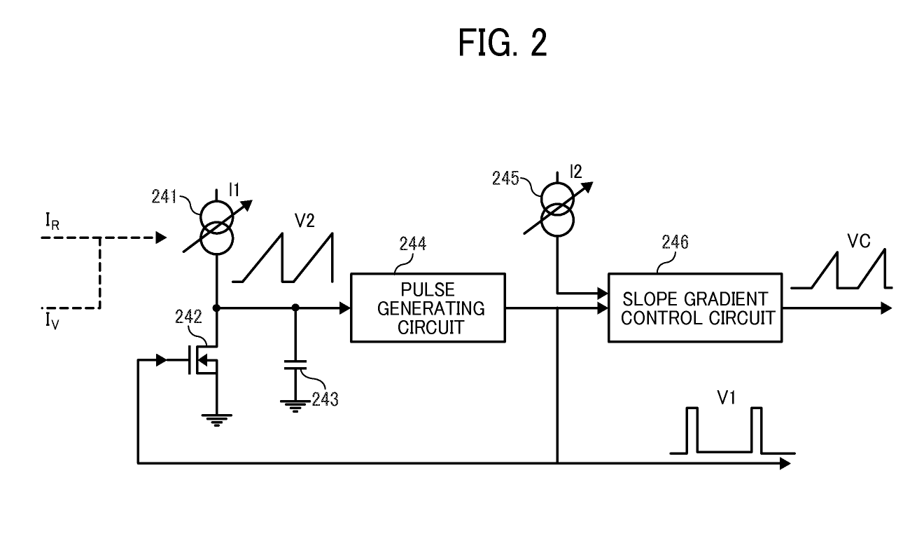

Next, an example of a configuration of the slope voltage generation circuit 24 described above will be described with reference to FIG. 2. The slope voltage generation circuit 24 includes a current source 241, a capacitor 243 , a discharge switch 242, a slope gradient control circuit 246, a current source 245 and a pulse generating circuit 244.

The current source 241 outputs a current corresponding to the variable current IV and the reference current IR, to the discharge switch 242. The capacitor 243 and the discharge switch 242 are connected in parallel to each other and such combination (i.e. 243 and 242 in parallel) is connected in series with the current source 241. The pulse generating circuit 244 generates a square wave signal V1 based on the slope waveform signal slope voltage V2 having a slope which is variable depending on the amount of the current I1 that flows from the current source 241. From the pulse generation circuit 244, the square wave signal V1 is fed back to the gate of the discharge switch 242.

In addition, the current source 245 (which is configured similarly to the current source 241) supplies a current I2 to the gradient control circuit 246. The slope gradient control circuit 246 controls the inclination of the slope voltage VC via the pulse generating circuit 244. That is, the slope voltage VC has a voltage slope controlled by the slope gradient control circuit 246 to be similar to the voltage slope of the slope waveform signal voltage V2.

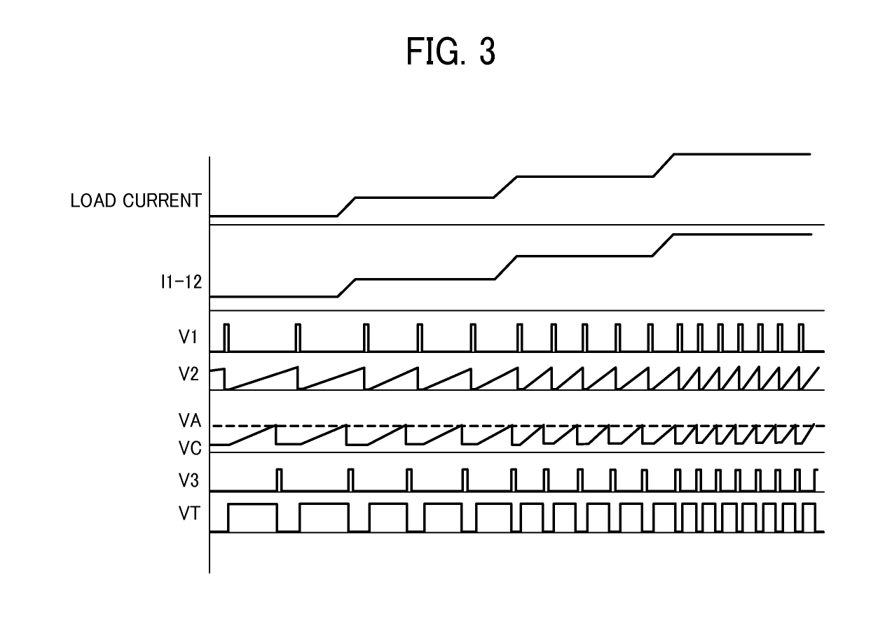

Next, an example of the operation of the switching regulator of the present embodiment will be described with reference to a timing chart showing in FIG. 3 a load current waveform corresponding to each of the voltage waveforms. In FIG. 3, in order from the top, the waveform of the following are shown, the load current IL, the current I1 and 12 flowing from the current sources 241 and 245, respectively, the square wave signal V1, the slope voltage V2, the error voltage signal VA, slope voltage VC, the PWM control signal V3, and the switching drive voltage VT.

Specifically, the waveform of the slope voltage V2 reflects operation of the capacitor 243 which is charged by the current I1. When the voltage value of the slope voltage V2 reaches a predetermined level, the square wave signal V1 is generated in the pulse generating circuit 244. For example, the predetermined level refers to the apex of the inclined slope of the waveform of the slope voltage V2. That is, as shown, when it reaches the top of the slope voltage, the square wave signal V1 becomes high (H) level.

When the square wave signal V1 changes from high level (H) to the low level (L), charge stored in the capacitor 243 is discharged through the discharge switch 242, and the slope voltage V2 is discharged. That is, when the process proceeds to the lowest point from the top, the waveform of the slope voltage V2 becomes low level (L) square wave signal V1.

When the square wave signal V1 is shifted to the low level (L) from the high level (H), again, the current I1 is charged in the capacitor 243, the slope voltage V2 is generated. By repeating this cycle, square wave of voltage control signal can be made to depend on the load current. That is, according to the present exemplary embodiment, by varying the amount of current depending on the amount of the load current flowing from the constant current source, it is possible to obtain a square wave control voltage signal corresponding to the load current.

In the present exemplary embodiment, the switching regulator controls the duty ratio of the switching pulse (for example, make on-time shorter) as the pulse width becomes narrower when the load current is large. In addition, the switching regulator controls the duty ratio (for example, make on-time longer) of the switching pulse width to be wider when the load current is small.

In addition, the switching regulator controls to reduce the switching frequency when the load current is relatively larger, and the switching regulator controls so as to increase the switching frequency when the load current is relatively smaller.

Specifically, as shown in the left side of FIG. 3, when the load current is small, the current I1 flowing in the current source 241 is reduced, for relaxing the inclination of the waveform of the slope voltage V2, and switching in the signal VT is made to be less frequent. On the other hand, as shown on the right side of FIG. 3, when the load current is large, and the current I1 flowing in current source 241 is increased, the slope level of the waveform of the slope voltage V2 is increased, and the switching operations are made more frequent.

In the present embodiment, as described above, the reference current circuit 22 according to the current control circuit for controlling the output current outputs a reference current IR to the slope voltage generating circuit 24 for determining the lowest frequency of the slope voltage. Therefore, even when the output current is controlled to zero, the frequency of the slope voltage V2 (i.e. the signal of the current I1 is controlled so as not to be below 20 kHz (e.g., below the human hearing range).

Further, the slope gradient control circuit 246 operates a circuit for determining the slope of the triangular wave slope voltage VC in the example shown in FIG. 2. Thus, it is not necessary to change the operating point of the error amplification circuit 26, and it is possible to simplify the circuit configuration. When the level of the slope voltage signal VC (i.e. the portion shown at the top of slope) exceeds the level of the error voltage signal VA (indicated by the broken line in FIG. 3), the output of the PWM comparator 27 is inverted, and the voltage of the slope voltage signal VC is discharged. Then, at the timing at which the square wave signal V1 is shifted to a low level (L) from the high level (H), it starts the charge.

The driving voltage VT rises when the square wave signal V1 is input to the Set input of the RS flip-flop 28, and the switching driving voltage VT falls when (based on comparison of the VC signal with the VA signal) the output signal V3 of the PWM comparator 27 is input to the Reset input of the RS flip-flop 28.

That is, the V1 signal is employed to control the switching frequency according to the load current, and the output signal V3 is employed to reduce switching loss and to reduce the ripple voltage to control the on period to shorten the duty ratio of the switching driving voltage VT.

By controlling the duty of the switching pulse and the switching frequency in response to changes in load current, it is possible to reduce the ripple of the output voltage and switching losses. Therefore, it is possible to provide a switching regulator which is efficient as described above.

Hereinabove, a switching regulator and method for controlling the switching regulator according to an exemplary embodiment are explained. However, the present invention is not limited to the above described embodiment, and various modifications and improvements may be made within the scope of the present invention.

The present application is based on and claims the priority of Japanese Patent Application No. 2013-069291 filed with the Japanese Patent Office on May 1, 2013, the entire contents of which are hereby incorporated herein by reference

What is claimed is:

1. A switching regulator comprising:
a control circuit including a switching drive voltage generating circuit to generate a switching signal to control a switching element to be a connected a load, wherein the control circuit is further configured to control both a duty ratio of the switching signal and a frequency of the switching signal in accordance with an amount of a load current.

2. The switching regulator as claimed in claim 1, wherein the control circuit controls a pulse width of the switching signal to be relatively narrower as the load current becomes larger, and controls the pulse width of the switching signal to be relatively wider when the load current becomes smaller.

3. A switching regulator comprising:
a switching element to be connected to a load, to generate an output voltage of the switching regulator;
an error amplifier to output an error voltage signal obtained by amplifying a voltage difference between a reference voltage and a feedback voltage which is proportional to the output voltage output to the load;
a slope voltage generation circuit to generate a square wave signal and a slope voltage that is varied in accordance with an amount of the output current;
a PWM comparator to compare the error voltage signal with the slope voltage and output a PWM signal; and
a switching driving voltage generation circuit to generate a switching driving voltage that controls the switching element in accordance with the square wave and the PWM signal.

4. The switching regulator as claimed in claim 3, further comprising:
a current control circuit to control the amount of the output current, the current control circuit including:
a reference current circuit to output a reference current value, for determining a lowest frequency of the slope voltage, to the slope voltage generating circuit;
a current setting circuit to set a load current value of the load and a variable current value to vary inclination of the slope voltage based on an external signal; and
a load current control circuit to control an amount of the load current flowing through the load to the current value set by the current setting circuit.

5. The switching regulator as claimed in claim 4, wherein the slope voltage generation circuit comprises:
a current source to flow a current corresponding to the variable current value set by the current setting circuit;
a capacitor and a discharge switch connected in parallel to each other, the combination of the capacitor and discharge switch connected in parallel being connected in series with the current source;
a pulse generating circuit to generate the square wave signal based on the slope waveform signal slope voltage having an inclination which is variable depending on an amount of the current that flows from the current source; and
a slope gradient control circuit to control the inclination of the slope voltage via the pulse generating circuit.

6. A method performed by a switching regulator for controlling a switching element connecting a load, to generate an output voltage to the load, the method comprising:
generating a driving voltage to control both a duty ratio of the switching signal and a frequency of the switching signal in accordance with an amount of a load current flowing through the load; and
applying the driving voltage to the switching element.
